(19) United States
(12) Patent Application Publication
(10) Pub. No.: US 2013/0060496 A1
(43) Pub. Date: Mar. 7, 2013

(54) WIRELESSLY-POWERED ELECTRICALLY-OPERATED DEVICE

(71) Applicant: Hiroaki NARITA, Tokyo (JP)

(72) Inventor: Hiroaki NARITA, Tokyo (JP)

(73) Assignee: AZBIL CORPORATION, Tokyo (JP)

(21) Appl. No.: 13/600,202

(22) Filed: Aug. 30, 2012

(30) Foreign Application Priority Data
Sep. 1, 2011 (JP) 2011-190449

(51) Int. Cl. G06F 19/00

(52) U.S. Cl. 702/62

(57) ABSTRACT

An operating period for a driving portion is defined. Prior to entering the operating period, it is defined as a forecasting operating period, the total amount of work of the driving portion for the forecasting operating period and a total required DC electric energy A for the device during the forecasting operating period are forecasted. Prior to entering into the forecasting operating period, a stored DC electric energy B, and an estimated DC electric energy C to be extracted from a wireless electric energy supply between the current time and the time of the end of the forecasting operating period are summed as a supplyable DC electric energy D for the period. The total required DC electric energy A for the forecasting operating period and the supplyable DC electric energy D are compared, and if D<A, the wireless electric energy supply is requested to increase its power distribution.

### CROSS-REFERENCE TO RELATED APPLICATION

This application claims priority to Japanese Patent Application 2011-190449, filed Sep. 1, 2011. The entirety of this application is incorporated herein by reference.

### FIELD OF TECHNOLOGY

The present invention relates to a wirelessly-powered electrically-operated device that receives wave motion, such as electromagnetic waves that are sent wirelessly, to use, as its operating power supply, energy that is extracted from the wave motion that is received.

### BACKGROUND

Conventionally, air-conditioning systems in office buildings, and the like, have been structured with sensors, for detecting environmental information, such as temperatures, humidity, and the like, provided in the supply air blowing vents, such as ducts, and provided with actuators for controlling the opening of the supply air blowing vents, and controlling devices for driving and controlling the actuators upon receipt of the environmental information, detected by the sensors, and receipt of operating instructions from users. It is desirable to make air-conditioning systems wireless in order to eliminate the need for the work involved in the connecting wires between the devices (sensors, actuators, and control devices) that structure the system.

In this air-conditioning system, sensors are able to operate on small amounts of electric energy, and thus can use internal batteries as the power supplies thereof. However, actuators that have driving portions require between 7 and 15 W of electric energy as an operating power supply, and so are provided with electric energy through connecting to an external power supply through a cable, because the capability of the batteries is inadequate.

In contrast, in recent years advances in technologies for wireless electric power distribution have enabled spatial transmission, using electromagnetic waves, of electric energy sufficient for operating an actuator. There are two methods for distributing electric energy to actuators wirelessly.

The first method, as disclosed in, for example, Japanese Unexamined Patent Application Publication 2007-244015 and Japanese Unexamined Patent Application Publication 2008-22429, is a method for transmitting electric energy to wireless devices through a transmission path wherein the electromagnetic waves for the power supply are isolated from an indoor space wherein humans are present (hereinafter termed the “closed-space wireless electric power distribution method”).

The other method, as disclosed in, for example, Japanese Unexamined Patent Application Publication 2005-261187 and Japanese Unexamined Patent Application Publication H11-32451, is a method for transmitting the electric energy of electromagnetic waves for the power supply to a wireless device using, as the transmission path, and indoor space wherein humans are present (hereinafter termed the “open-space wireless electric power distribution method”).

In systems that use these electric power distribution methods (known as “wireless electric power distribution systems”), devices that receive electromagnetic waves that are sent from wireless electric energy supplying devices, which extract DC electric energy through rectifying the electromagnetic waves that are received, and which use as their own operating power supplies the DC electric energy that is extracted (hereinafter termed “wirelessly-powered electrically-operated devices”), include devices where the operations are always uniform and unchanging, such as temperature sensors, humidity sensors, and the like (hereinafter termed “uniform operation devices”), and devices that may be in an operating state or a stopped state, and wherein, when in an operating state, the amount of work thereof may change over time, such as in an actuator (hereinafter termed “variable operation devices”).

In this case, if all of the wirelessly-powered electrically-operated devices that receive a supply of electric energy from the wireless electric energy supplying device are uniform operation devices, then it is possible to determine in advance an appropriate electric power distribution level from the wireless electric energy supplying device. However, if a variable operation device is included among the wirelessly-powered electrically-operated devices, then the electric energy used by the devices will vary over time, making it difficult to determine an appropriate level in advance, making it necessary to distribute electric energy at a maximum allowable level (a level at which there can be no effect on human beings and other systems), where if the electric energy used by the variable operation devices is less than the electric energy that can be obtained through the electric power distribution, then, as a result, the electric power distribution level will be excessive, resulting in wasted energy (electric power distribution). Conversely, if, in consideration of wasted energy, the electric power distribution level were reduced somewhat in electric power distribution, then if the electric energy required by the variable operation devices is more than anticipated, there would be the problem of inadequate energy (power reception).

The present invention is to solve such a problem, and the object thereof is to provide a wirelessly-powered electrically-operated device that does not produce wasteful electric power distribution or inadequate power reception.

### SUMMARY

An example of the present invention, in order to achieve at least the object set forth above, is a wirelessly-powered electrically-operated device including a wave receiving portion for receiving wave motion that is transmitted wirelessly, an electric energy extracting portion for extracting, as electric energy, the wave motion received by the wave receiving portion, an electricity storing portion for storing the electric energy extracted by the electric energy extracting portion, and a driving portion that is driven by receiving a supply of electric energy that is stored in the electricity storing portion. This has a work quantity forecasting device for defining, as an operating period for the driving portion, a specific period that is set in advance, and for defining, prior to entering into that operating period, the operating period as an operating period for forecasting, to forecast the total amount of work of the driving portion in the operating period for forecasting. This also includes a total required electric energy forecasting device for forecasting the total required electric energy in the device for the operating period for forecasting based on the total amount of work of the driving portion forecasted by the work quantity forecasting device. Also, a supplyable electric energy calculator for summing, prior to entering into the operating period for forecasting, an amount of electric energy that remains, at that time, in the electricity storing portion and an estimated electric energy to be extracted from the wave motion by the electric energy extracting portion between the current time and the time of the end of the operating period for forecasting, to calculate the summed electric energies as the supplyable electric energy that can be supplied during the operating period for forecasting. Additionally included is an electric energy comparing device for comparing the total required electric energy for the operating period for forecasting, forecasted by the total required electric energy forecasting device, and the supplyable electric energy for the operating period for forecasting, calculated by the supplyable electric energy calculator. Further has a notifying device for providing notification of information based on the comparison results by the electric energy comparing device.

Given the present example if the operating period of a driving portion is the period from 8:00 AM through 7:00 PM every day, then, prior to entering into the operating period on a given day, the operating period for that day is defined as an operating period for forecasting, where the total amount of work of the driving portion during the operating period for forecasting is forecasted, and the total required DC electric energy (A) within a given device during the operating period for forecasting is forecasted based on the forecasted total amount of work of the driving portion. Moreover, prior to entering into the operating period for forecasting, the DC electric energy (B) that remains at the present time in an electricity storing portion and the DC electric energy (C) that is estimated to be extracted from the wave motion by the rectifying portion from the present time to the end of the operating period for forecasting are totaled, where the total DC electric energy (B+C) is calculated as the supplyable DC electric energy (D) that can be supplied during the operating period for forecasting. Moreover, the total required DC electric energy (A) during the operating period for forecasting and the supplyable DC electric energy (D) during the operating period for forecasting are compared, and there is a notification depending on the comparison result.

In this way, in the present example, a total required DC electric energy (A) for an operating period for forecasting is forecasted, the supplyable DC electric energy (D) during the operating period for forecasting is calculated, the total required DC electric energy (A) for the operating period for forecasting and the supplyable DC electric energy (D) for the operating period for forecasting are compared, and a data notification is performed based on the comparison result. This enables the provision of notification of inadequate power reception if, on the wave motion transmitting side, the supplyable DC electric energy (D) for an operating period for forecasting is less than the total required DC electric energy (A) for the operating period for forecasting, and possible to provide notification of wasteful electric power distribution if the supplyable DC electric energy (D) during an operating period for forecasting is greater than the total required DC electric energy (A) during the operating period for forecasting.

In the present example, the work quantity forecasting device forecast the total amount of work for the driving portion over the operating period for forecasting. In this case, work quantity summing device are provided for measuring and summing the amounts of work of the driving portion, for example, during operating periods, and operating schedule storing device are provided for forecasting the total amount of work of the driving portion within the operating period for forecasting based on the total work quantity (amount of work) during the operating periods thus far (for example, the total work quantity during an operating period such as a “workday” or “non-workday”), summed by the work quantity summing device, and for storing an operating schedule for the operating period of the driving portion (for example, an operating schedule for the operating period for, for example, a “workday” or “non-workday”), making it possible to forecast the total amount of work of the driving portions for the operating period for forecasting based on the operating schedule within the operating period that is stored in these operating schedule storing device.

Moreover, in the present example the notifying device provide notification of information based on the results of a comparison by the electric energy comparing device. In this case if, for example, the supplyable DC electric energy (D) for an operating period for forecasting is less than the total required DC electric energy (A) during that operating period for forecasting, then there would be a notification of a request to increase the energy level of the wave motion that is transmitted. That is, if, for example, the supplyable DC electric energy (D) for an operating period for forecasting is less than the total required DC electric energy (A) during that operating period for forecasting, then there is an evaluation that there is a risk that the power reception during the operating period for forecasting would be inadequate were the current electric power distribution level to be maintained, and an increase the electric power distribution level is requested.

Moreover, in the present example, operating mode switch for switching between a normal operating mode and a low-power operating mode that can operate at low electric energy may be provided, and the operating mode may be switched from the normal operating mode to the low-power operating mode if the supplyable DC electric energy (D) for an operating period for forecasting is less than the total required DC electric energy (A) during that operating period for forecasting. In this case, the operating mode is switched automatically into the low-power operating mode when there is an evaluation that the supplyable DC electric energy (D) during an operating period for forecasting would be inadequate if in the normal operating mode. This reduces the total required DC electric energy (A) during the operating period for forecasting to extend the period over which the driving portion can operate.

Moreover, in the present example, if the supplyable DC electric energy (D) for an operating period for forecasting is less than the total required DC electric energy (A) during that operating period for forecasting, then along with switching the operating mode from the normal operating mode to the low-power operating mode, the total amount of work of the driving portion within the operating period for forecasting, if operating in the low-power operating mode, may be forecasted as the total amount of work when in the low-power operating mode, and a low-power operating mode total required DC electric energy (A′) within the device during the operating period for forecasting may be forecasted based on the low-power operating mode total amount of work forecasted for the driving portion, and this forecasted low-power operating mode total required DC electric energy (A′) for the operating period for forecasting may be compared to the supplyable DC electric energy (D) for the operating period for forecasting, and if the supplyable DC electric energy (D) for the operating period for forecasting is less than the low-power operating mode total required DC electric energy (A′) for the operating period for forecasting, then there may be a notification of a request for increasing the energy level of the wave motion that is transmitted. In this case, the operating mode is switched automatically into the low-power operating mode when there is an evaluation that the supplyable DC electric energy (D) during an operating period for forecasting would be inadequate if in the normal operating mode. Additionally, if there is an evaluation that there is a risk that the power reception during the operating period for forecasting can be inadequate even if the operating mode is switched into the low-power operating mode, then an increase in the electric power distribution level can be requested.

Note that while in the present example that, prior to entering into the operating period for forecasting, the DC electric energy (B) that remains at the present time in an electricity storing portion and the DC electric energy (C) that is estimated to be extracted from the wave motion by the rectifying portion from the present time to the end of the operating period for forecasting are totaled, where the total DC electric energy (B+C) is calculated as the supplyable DC electric energy (D) that can be supplied during the operating period for forecasting, there may also be cases wherein electric energy is received wirelessly by the wirelessly-powered electrically-operated device during intervals of time wherein the humans are absent, such as nighttime hours, and no electric energy is supplied wirelessly during the period of operation of the driving portion. In the case of such an approach, in the present example the estimated DC electric energy (C) to be extracted from the wave motion by the rectifying portion between the present time and the end of the operating period for forecasting would be zero, and thus the supplyable DC electric energy (D) for which supply is possible during the operating period for forecasting would be only the DC electric energy (B) that remains at the present time in the electricity storing portion. While, in this case, it is not possible to increase the electric power distribution level during the operating period for forecasting, the notification of the results of the comparison by the electric energy comparing device makes it possible to increase the electric power distribution level during the electric energy supplying period after the operating period for forecasting, to eliminate inadequacies in the power reception.

Moreover, in another example the wirelessly-powered electrically-operated device includes a wave receiving portion for receiving wave motion that is transmitted wirelessly, an energy extracting portion for extracting, as energy, the wave motion received by the wave receiving portion, an electricity storing portion for storing the energy extracted by the energy extracting portion, and a driving portion that is driven by receiving a supply of energy that is stored in the electricity storing portion.

The example can have a work quantity forecasting device for defining, as an operating period for the driving portion, a specific period that is set in advance, and for defining, prior to entering into that operating period, the operating period as an operating period for forecasting, to forecast the total amount of work of the driving portion in the operating period for forecasting. Also including a total required energy forecasting device for forecasting the total required energy in the device for the operating period for forecasting based on the total amount of work of the driving portion forecasted by the work quantity forecasting device. The example also has a supplyable energy calculator for summing, prior to entering into the operating period for forecasting, an amount of energy that remains, at that time, in the electricity storing portion and an estimated energy to be extracted from the wave motion by the energy extracting portion between the current time and the time of the end of the operating period for forecasting, to calculate the summed energies as the supplyable energy that can be supplied during the operating period for forecasting.

Further including, an energy comparing device for comparing the total required energy for the operating period for forecasting, forecasted by the total required energy forecasting device, and the supplyable energy for the operating period for forecasting, calculated by the supplyable energy calculator; and a notifying device for providing notification of information based on the comparison results by the energy comparing device. These can be used to compare using energies instead of electric energies.

Given an example of the present invention, a specific period can be established in advance and can be used as an operating period for a driving portion, and before entering into this operating period, that operating period can be defined as an operating period for forecasting, where the total amount of work of the driving portion during the operating period for forecasting is forecasted, a total required energy (A) in the device during the operating period for forecasting is forecasted based on the forecasted total amount of work of the driving portion during the operating period for forecasting, prior to entering into the operating period for forecasting the energy (B) currently remaining in the electricity storing portion and the estimated energy (C) that can be extracted from the wave motion by the rectifying portion from the current point in time until the end of the estimated operating period are added together, where this totaled energies (B+C) is calculated as the supplyable energy (D) during the operating period for forecasting, where the total required energy (A) during the operating period for forecasting and the supplyable energy (D) during the operating period for forecasting are compared and there is a notification of information based on the comparison result, thus making it possible to provide notification to the wave motion transmitting side that the power reception can be inadequate if the supplyable energy (D) during the operating period for forecasting is less than the total required energy (A) during the operating period for forecasting, and making it possible to provide notification of wasteful electric power distribution if the supplyable energy (D) during the operating period for forecasting is greater than the total required energy (A) during the operating period for forecasting, and the like, thus enabling a prevention of wasteful electric power distribution and of inadequate power reception.

### BRIEF DESCRIPTIONS OF THE DRAWINGS

FIG. 1 is a diagram illustrating an example of a wireless electric power distributing system using a wirelessly-powered electrically-operated device according to the present invention.

FIG. 2 is a timing chart explaining the function for determining the electric power distribution level in the system controlling portion in the wireless electric energy supplying device in the wireless electric power distributing system in an example of the present invention.

FIG. 3 is a functional block diagram of an example of the system controlling portion in the wireless electric energy supplying device in the wireless electric power distributing system.

FIG. 4 is a functional block diagram of the example of the controlling portion in an electrically-operated device in the wireless electric power distributing system of this example.

FIG. 5 is a functional block diagram of another example of the controlling portion in an electrically-operated device in the wireless electric power distributing system.

FIG. 6 is a functional block diagram of a further example of the controlling portion in an electrically-operated device in the wireless electric power distributing system.

FIG. 7 is a functional block diagram of a yet further example of the controlling portion in an electrically-operated device in the wireless electric power distributing system.

FIG. 8 is a diagram illustrating portions of an example of another wireless electric power distributing system using a wirelessly-powered electrically-operated device.

FIG. 9 is a diagram illustrating portions of another example of yet another wireless electric power distributing system using a wirelessly-powered electrically-operated device.

### DETAILED DESCRIPTION

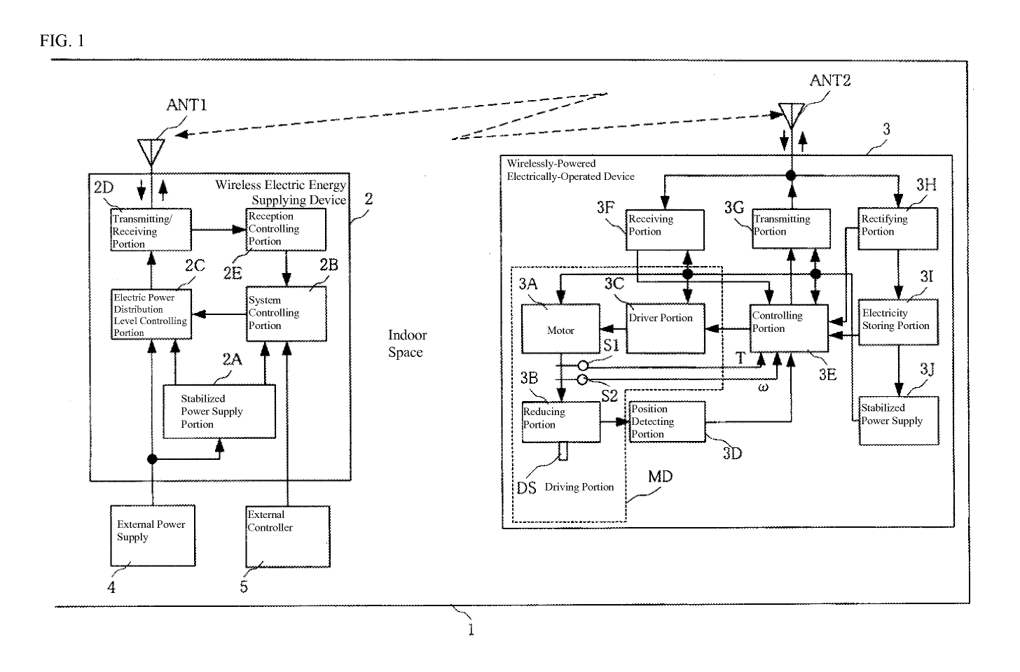

An example of an Open-Space Wireless electric power Distributing System is explained in detail based on the drawings below. FIG. 1 is a diagram illustrating portions of an example of a wireless electric power distributing system using a wirelessly-powered electrically-operated device according to the present invention.

In this figure, 1 is an indoor space, 2 is a wireless electric energy supplying device located within the indoor space 1, 3 is a wirelessly-powered electrically-operated device (hereinafter termed simply an “electrically-operated device”) located within the indoor space 1, 4 is an external power supply, and 5 is an external controller that monitors the system as a whole and that transmits, for example, degree-of-opening instruction information to the actuators.

Note that, as can be understood easily from FIG. 1, the wireless electric energy supplying device 2 and the electrically-operated device 3 are disposed within the indoor space 1. However, insofar as they can mutually communicate wirelessly through the indoor space 1, the wireless electric energy supplying device 2 and the electrically-operated device 3 can be located outside of the indoor space 1. Moreover, in this wireless electric power distributing system the electrically-operated device 3 corresponds to the wirelessly-powered electrically-operated device referred to in the present examples.

Furthermore, the wireless electric energy supplying device 2 corresponds to the wave motion transmitting device for transmitting wave motion. Furthermore, a plurality of electrically-operated devices 3 can be provided.

The wireless electric energy supplying device 2 can include a stabilized power supply portion 2A for receiving a power supply from an external power supply 4 and producing a stabilized power supply voltage; a system controlling portion 2B and an electric power distribution level controlling portion 2C that run on the power supply voltage received from the stabilized power supply portion 2A; a transmitting/receiving portion 2D for transmitting electromagnetic waves to the indoor space 1 and receiving electromagnetic waves from the indoor space 1 through an antenna ANT1; and a reception controlling portion 2E for transmitting, to the system controlling portion 2B, information from the outside received through the transmitting/receiving portion 2D.

The electrically-operated device 3 can be an actuator having a driving portion, and includes a motor 3A; a reducing portion 3B for reducing the speed of rotation of the motor 3A and transmitting it to a driveshaft DS. Also included is a driver portion 3C driving the motor 3A; and a position detecting portion 3D for detecting an angular position of the driveshaft DS through the reducing portion 3B. Further included is a controlling portion 3E for controlling, through the driver portion 3C, the rotation of the motor 3A, while receiving feedback of the angular position of the driveshaft DS, detected by the position detecting portion 3D; a torque sensor S1 for detecting the torque T when the motor 3A is rotating; and an angular velocity sensor S2 for detecting the angular velocity w when the motor 3A is rotating. The torque T that is detected by the torque sensor S1 and the angular velocity w that is detected by the angular velocity sensor S2 are provided to the controlling portion 3E.

Note that in this electrically-operated device 3, the antenna ANT1 corresponds to the wave receiving portion referred to in the present examples, and the structure including the motor 3A, the reducing portion 3B, and the driver portion 3C correspond to the driving portion referred to in the present examples. In FIG. 1, the structure including the motor 3A, the reducing portion 3B, and the driver portion 3C is surrounded by a dotted line, and is illustrated as the “driving portion MD.”

Moreover, the electrically-operated device 3 includes a receiving portion 3F for transmitting, to the controlling portion 3E, environment information such as temperatures, humidity levels, and the like, from wireless sensors (not shown) in the indoor space 1, received through an antenna ANT2, and degree-of-opening instruction information, through an external controller 5, from the wireless electric energy supplying device 2. Also, a transmitting portion 3G for transmitting information from the controlling portion 3E through the antenna ANT2 to the indoor space 1; a rectifying portion 3H for converting and rectifying, into a DC current, electromagnetic waves from the wireless electric energy supplying device 2, received through the antenna ANT2; an electricity storing portion 3I for storing electric charge due to the electric current that is rectified by the rectifying portion 3H; and a stabilized power supply portion 3J for producing a stabilized power supply voltage from the charge that is stored in the electricity storing portion 3I. The power supply voltage generated by the stabilized power supply portion 3J is provided to the motor 3A, the driver portion 3C, the controlling portion 3E, the receiving portion 3F, and the transmitting portion 3G. Moreover, information indicating the magnitude of the electric current in the rectifying portion 3H and the amount of electricity stored in the electricity storing portion 3I is provided to the controlling portion 3E.

In the wireless electric energy supplying device 2, the system controlling portion 2B has an electric power distribution level determining function for evaluating whether or not there is a human present in the indoor space 1 depending on a schedule that indicates the possibility of the presence or absence of the human in the indoor space 1, and for determining, as an electric power distribution level, a setting value for the level for the electromagnetic waves to be transmitted from the antenna ANT1 to the indoor space 1 depending on the result of the evaluation as to whether or not there is a human present. Note that the schedule indicating the possibility of presence or absence of humans in the indoor space 1 that is used by the system controlling portion 2B may be provided in the system controlling portion 2B in advance, or may be provided from the outside, through a route comprising the antenna ANT1, the transmitting/receiving portion 2D and the reception controlling portion 2E, so as to be changeable.

Moreover, in the electrically-operated device 3, the controlling portion 3E has a supplyable electric energy evaluating function for using a specific period that is set in advance as the operating period for the driving portion MD, and, prior to entering into that operating period, setting that operating period as an operating period for forecasting, to forecast the total required DC electric energy within the device in that operating period for forecasting, to compare the forecasted total required DC electric energy to the DC electric energy that can be supplied during the operating period for forecasting (the supplyable DC electric energy), and to provide notification to the wireless electric energy supplying device 2 of information based on the results of the comparison.

In the present example, the electric power distribution level determining function in the system controlling portion 2B in the wireless electric energy supplying device 2, the supplyable electric energy evaluating function in the controlling portion 3E in the electrically-operated device 3, and the like, are embodied in hardware comprising a processor and a memory device, and a program that cooperates with this hardware to embody these functions.

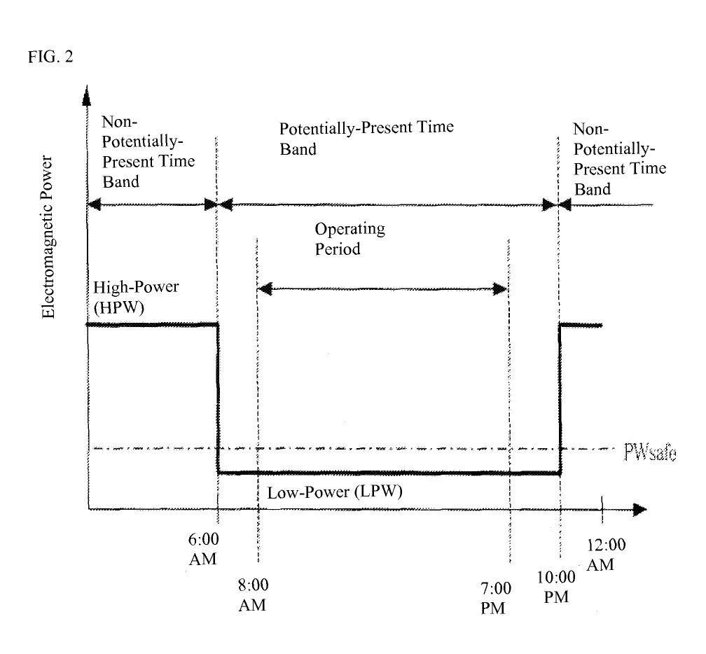

An example of determining the power distribution level in the wireless electric energy supplying device is below. First the electric power distribution level determining function in the system controlling portion 2B of the wireless electric energy supplying device 2 is explained in reference to the timing chart illustrated in FIG. 2.

Note that in this example the time band from 6:00 AM to 10:00 PM is established as the time band wherein humans may be present (a “potentially present time band”), and the remaining time band is established as a time band wherein humans cannot be present (the “not potentially present time band”), as a schedule indicating the possibility of presence or absence of humans in the indoor space 1, in the system controlling portion 2B.

An example of if the evaluation is that a human is present in the indoor space 1. The system controlling portion 2B monitors the current time, and if the current time is in the time band from 6:00 AM to 10:00 PM, evaluates the time band in the indoor space 1 to be a potentially present time band. That is, the probability that there is a human in the indoor space 1 is high, so the evaluation is that there is a human in the indoor space 1. Given this, the system controlling portion 2B sets the setting value for the level of the electromagnetic waves that are transmitted to the indoor space 1 (the electric power distribution level) to the low-power setting value LPW, because of the evaluation result that there is a human within the indoor space 1, and sends this low-power setting value LPW to the electric power distribution level controlling portion 2C.

The low-power setting value LPW in this case is an electromagnetic wave level of a degree that does not have an effect on human body, as established in the Standards for Radiofrequency Protection, where if the frequency is between 1.5 Hz and 300 GHz, the upper limit value for the power density in an uncontrolled environment is defined as 1 mW/cm², where the upper limit value for the power density is defined as 5 mW/cm² for a controlled environment. In FIG. 2, the power corresponding to the upper limit value of the power density in this case is indicated as PWsafe, where the low-power setting value LPW is set so as to be smaller than this power level PWsafe.

Consequently, when the evaluation is that there is a human present in the indoor space 1, a low-power electromagnetic wave, which is smaller than the power level PWsafe, wherein there is no risk of affecting the human body, is sent into the indoor space 1 by the wireless electric energy supplying device 2 through the control of the electric power distribution level by the electric power distribution level controlling portion 2C in accordance with the low-power setting value LPW.

An example if the evaluation is that a human is not present in the indoor space 1 can include that the system controlling portion 2B monitors the current time, and if the current time is not in the time band from 6:00 AM to 10:00 PM, evaluates the time band in the indoor space 1 to be a not-potentially-present time band. That is, the probability that there is a human in the indoor space 1 is low, so the evaluation is that there is no human in the indoor space 1.

Given this, the system controlling portion 2B sets the setting value for the level of the electromagnetic waves transmitted into the indoor space 1 (the electric power distribution level) to a high-power setting value HPW, given the evaluation result that there is no human in the indoor space 1, and sends the high-power setting value HPW to the electric power distribution level controlling portion 2C.

In this case, the high-power setting value HPW is an electromagnetic wave wherein the power is larger than the power level PWsafe, which would have no risk of effecting the human body, with electric energy able to adequately ensure the operating electric energy for the electrically-operated device 3 (which can be a wireless device). Moreover, this is electric energy wherein there is no risk of affecting the other systems that exist within the indoor space 1, such as emergency warning systems (not shown).

Consequently, when there has been an evaluation that there is no human in the indoor space 1, electromagnetic waves of higher power than the power level PWsafe wherein there would be no risk of affecting the human body are transmitted from the wireless electric energy supplying device 2 into the indoor space 1 through control of the electric power distribution level by the electric power distribution level controlling portion 2C in accordance with the high-power setting value HPW.

The electromagnetic waves that are transmitted from the wireless electric energy supplying device 2 (the low-power electromagnetic waves and high-power electromagnetic waves) pass through the indoor space 1 to be received by the electrically-operated device 3. In this electrically-operated device 3, the electromagnetic waves from the wireless electric energy supplying device 2 are sent to the rectifying portion 3H. The rectifying portion 3H converts and rectifies these electromagnetic waves into an electric current, where the rectified electric current is sent to the electricity storing portion 3I. The electricity storing portion 3I stores the electric charge from the electric current from the rectifying portion 3H.

In this case, when there has been an evaluation that there is a human present in the indoor space 1, electric energy from the low-power electromagnetic waves is received from the wireless electric energy supplying device 2 and electricity is stored in the electricity storing portion 3I. When there has been an evaluation that there is no human present in the indoor space 1, electric energy from the high-power electromagnetic waves is received from the wireless electric energy supplying device 2 and electricity is stored in the electricity storing portion 3I

At this point, the electric energy is obtained through the low-power electromagnetic waves from the wireless electric energy supplying device 2 is small if there has been an evaluation that there is a human present in the indoor space 1. However, in this case the electric energy that is obtained through the high-power electromagnetic waves when the evaluation is that there was no human present in the indoor space 1 is stored in the electricity storing portion 3I. When there is an evaluation that there is a human present in the indoor space 1, the electric energy that is stored in the electricity storing portion 3I is used to secure the power supply electric energy when receiving the low-power electromagnetic waves.

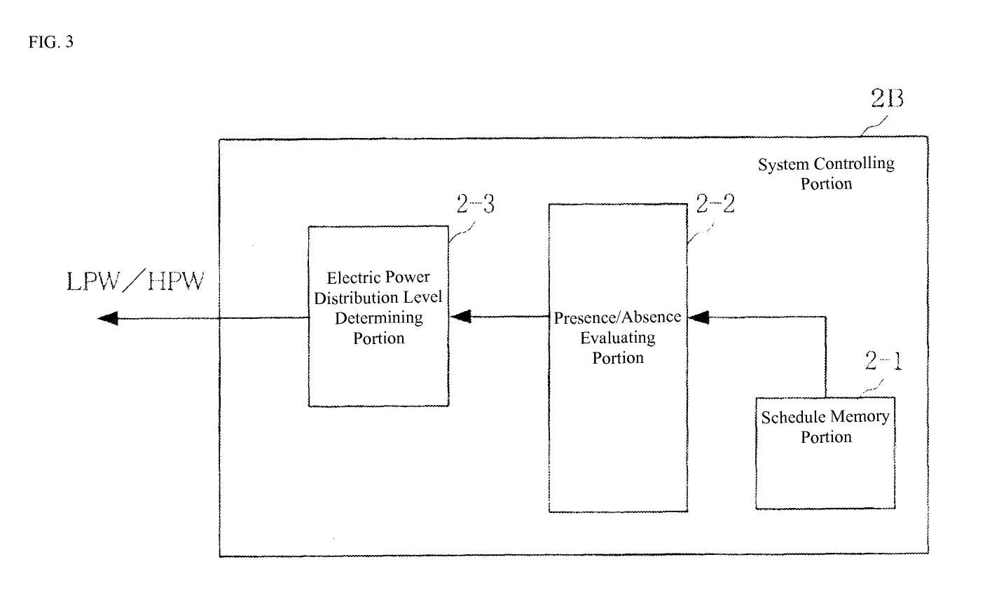

FIG. 3 is a functional block diagram of portions of the system controlling portion 2B within the wireless electric energy supplying device 2. The system controlling portion 2B includes a schedule memory portion 2-1, a presence/absence evaluating portion 2-2, and an electric power distribution level determining portion 2-3, where a schedule that indicates the potential for the presence or absence of humans in the indoor space 1 is stored in the schedule memory portion 2-1.

In the system controlling portion 2B, the presence/absence evaluating portion 2-2 evaluates whether or not there is a human in the indoor space 1 in accordance with the schedule that is stored in the schedule memory portion 2-1. The electric power distribution level determining portion 2-3 determines whether to set the setting value for the level of the electromagnetic waves to be transmitted to the indoor space 1 (the electric power distribution level) to the low-power setting value LPW or to the high-power setting value HPW.

An example of evaluating the supplyable electric energy in the electrically-operated device is below. The supplyable electric energy evaluating function of the controlling portion 3E of the electrically-operated device 3 is explained next. Note that in the present example the controlling portion 3E sets the period from 8:00 AM through 7:00 PM each day as the operating period for the driving portion MD, and, immediately prior to entering into this operating period, sets this operating period as an operating period for forecasting, and performs an evaluation of the supplyable electric energy, explained below. The time at which this evaluation is started is known as the “supplyable electric energy evaluation time.”

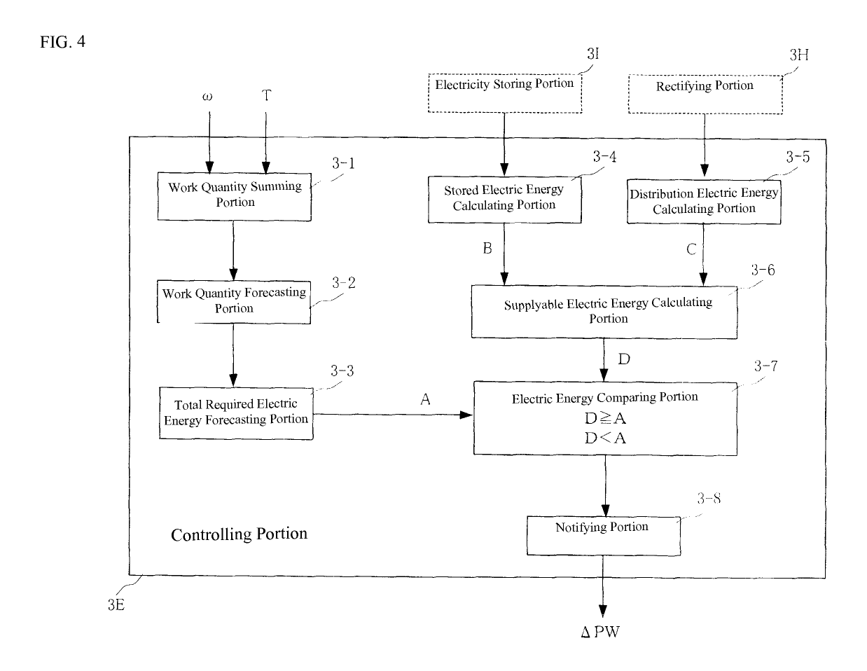

FIG. 4 shows an example of a functional block diagram for portions of the controlling portion 3E within the electrically-operated device 3. In this example, the controlling portion 3E includes a work quantity summing portion 3-1, an work quantity forecasting portion 3-2, a total required electric energy forecasting portion 3-3, a stored electric energy calculating portion 3-4, an distribution electric energy calculating portion 3-5, a supplyable electric energy calculating portion 3-6, an electric energy comparing portion 3-7, and a notifying portion 3-8.

In the controlling portion 3E, the work quantity summing portion 3-1 inputs the torque T from the torque sensor S1 and the angular velocity ω from the angular velocity sensor S2, and sums the amounts of work of the driving portion MD within the operating period as ΣT·ω·t(J). In this case, every day, each time an operating period of the driving portion MD is ended, the total amount of work of the driving portion MD during that operating period is calculated, and the calculated total amount of work is stored corresponding to the day of the week on that day. Note that the torque T may be obtained from a calculation from the motor terminal voltage, the motor current, or the speed of rotation of the motor. Moreover, the angular velocity w may be obtained from a calculation from the angle of rotation and the time of rotation.

In the controlling portion 3E, when the supplyable electric energy evaluating time is reached, the work quantity forecasting portion 3-2 forecasts the total amount of work of the driving portion MD within the operating period for forecasting for the day based on the total amount of work for the driving portion MD during the operating periods up to the previous day, which are stored in the work quantity summing portion 3-1. In this case, if the operating period for forecasting for the day is a workday operating period, then, of the operating periods up until the previous day that are stored in the work quantity summing portion 3-1, the total amount of work of the operating period of the most recent workday is used as the total amount of work for the operating period for forecasting. Moreover, if the operating period for forecasting for the day is a non-workday operating period, then, of the operating periods up until the previous day that are stored in the work quantity summing portion 3-1, the total amount of work of the operating period of the most recent non-workday is used as the total amount of work for the operating period for forecasting. Note that if the operating period for forecasting is a workday, the total amount of work for the operating period for the most recent day that is the same day of the week may be used as the total amount of work for the operating period for forecasting. In the controlling portion 3E, the total required electric energy forecasting portion 3-3 forecasts a total required DC electric energy A for the device for the operating period for forecasting based on the total amount of work of the driving portion MD forecasted by the work quantity forecasting portion 3-2. In this case, the total amount of work of the driving portion MD, forecasted by the work quantity forecasting portion 3-2, is converted into a DC electric energy, where that converted DC electric energy is added to the electric energies required by the controlling portion 3E, the receiving portion 3F, the transmitting portion 3G, and the like, to produce the total required DC electric energy A for the device for the operating period for forecasting.

When the supplyable electric energy evaluating time has arrived, in the controlling portion 3E, the stored electric energy calculating portion 3-4 calculates the stored energy as ½ CV²(J) from the capacitance value C for the electricity storing portion 3I and the charge voltage value V at the present time, and converts this stored energy into an electric energy value to calculate the DC electric energy (the stored electric energy) B remaining at that time in the electricity storing portion 3I.

When the supplyable electric energy evaluating time is reached, in the controlling portion 3E the distribution electric energy calculating portion 3-5 calculates the per-unit-time power W based on the electric current value and the voltage at that time in the rectifying portion 3H, and with the time interval from the present time until the time at the end of the operating period for forecasting defined as t1, calculates an estimated DC electric energy (electric power distribution) C that will be extracted from the electromagnetic waves from the wireless electric energy supplying device 2 by the rectifying portion 3H as the W·t1.

In the controlling portion 3E, the supplyable electric energy calculating portion 3-6 adds together the DC electric energy (the stored electric energy) B that is currently remaining in the electricity storing portion 3I, calculated by the stored electric energy calculating portion 3-4, and the estimated DC electric energy (the electric power distribution) C that is to be extracted from the electromagnetic waves from the wireless electric energy supplying device 2 by the rectifying portion 3H between the current time and the time at the end of the operating period for forecasting, calculated by the distribution electric energy calculating portion 3-5, to calculate, as the supplyable DC electric energy D that can be supplied during the operating period for forecasting, this summed DC electric energy B+C.

In the controlling portion 3E, the electric energy comparing portion 3-7 compares the total required DC electric energy A of the operating period for forecasting, calculated by the total required electric energy forecasting portion 3-3, and the supplyable DC electric energy D for the operating period for forecasting, calculated by the supplyable electric energy calculating portion 3-6, and sends the comparison result to the notifying portion 3-8.

If, based on the comparison result by the electric energy comparing portion 3-7, the supplyable DC electric energy D for the operating period for forecasting is less than the total required DC electric energy A for the device for the operating period for forecasting (D<A), then the notifying portion 3-8 provides notification, to the wireless electric energy supplying device 2, of a request to increase the electric power distribution level by a specific amount ΔPW.

In this case, the controlling portion 3E waits for the time required for the electric power distribution level in the wireless electric energy supplying device 2 to increase by the specific quantity ΔPW, and then repeats the calculation of the stored electric energy B by the stored electric energy calculating portion 3-4 and the distribution electric energy C by the distribution electric energy calculating portion 3-5. Given this, the stored electric energy B, calculated by the stored electric energy calculating portion 3-4, and the distribution electric energy C, calculated by the distribution electric energy calculating portion 3-5 are totaled by the supplyable electric energy calculating portion 3-6, to recalculate the supplyable DC electric energy D for the operating period for forecasting, and then the total required DC electric energy A for the operating period for forecasting, calculated by the total required electric energy forecasting portion 3-3, and the supplyable DC electric energy D for the operating period for forecasting, calculated by the supplyable electric energy calculating portion 3-6, are compared again in the electric energy comparing portion 3-7.

If here the supplyable DC electric energy D for the operating period for forecasting is still less than the total required DC electric energy A for the operating period for forecasting (D<A), then a notification is sent again from the notifying portion 3-8 to the wireless electric energy supplying device 2 requesting another increase in the electric power distribution level by the specific amount ΔPW, and the operation described above is repeated. This operation is repeated until the supplyable DC electric energy D for the operating period for forecasting reaches or exceeds the total required DC electric energy A for the operating period for forecasting (D≧A). This protects against an insufficiency in the received electric energy in the electrically-operated device 3, ensuring proper operation of the electrically-operated device 3 during the operating period for forecasting.

Note that while the wireless electric energy supplying device 2 receives and follows the requests, from the electrically-operated device 3, for increasing the electric power distribution level by the specific amounts ΔPW, if the evaluation by the system controlling portion 2B is that there is a human present in the indoor space 1, it does not change the electric power distribution level so as to exceed PWsafe. While, in this case, it is not possible to cause the supplyable DC electric energy D for the operating period for forecasting to be equal to or greater than the total required DC electric energy A for the operating period for forecasting (D≧A) in the electrically-operated device 3, a state is maintained that does not exceed the power level PWsafe wherein there is no risk of affecting a human body within the indoor space 1.

Moreover, if, based on the comparison result by the electric energy comparing portion 3-7, the supplyable DC electric energy D for the operating period for forecasting is greater than or equal to the total required DC electric energy A for the operating period for forecasting (D≧A), then if that difference is greater than a value that has been set in advance, the notifying portion 3-8 provides a notification to the wireless electric energy supplying device 2 requesting a decrease in the electric power distribution level by a specific amount ΔPW. This prevents waste of the electric power distributed in the wireless electric energy supplying device 2.

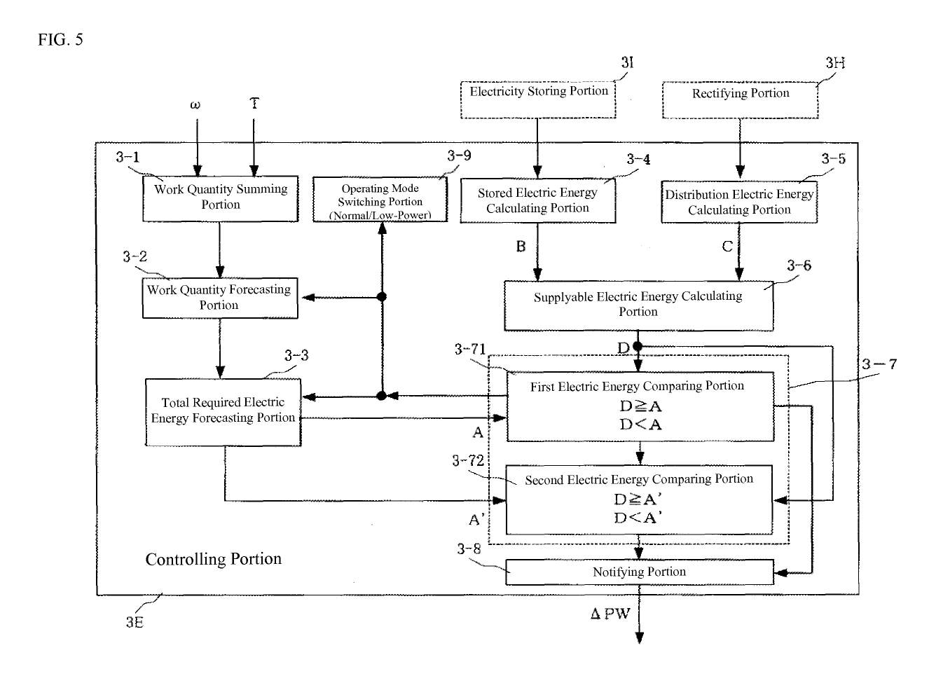

FIG. 5 shows another example of a functional block diagram of portions of the controlling portion 3E in the electrically-operated device 3. In this example, the controlling portion 3E can have an operating mode switching portion 3-9 for switching between a normal operating mode and a low-power operating mode (an operating mode enabling operation at lower power than the normal operating mode). Moreover, it has a first electric energy comparing portion 3-71 and a second electric energy comparing portion 3-72 as the electric energy comparing portion 3-7.

In the controlling portion 3E, the operating mode switching portion 3-9 normally is in a state that is switched to the normal operating mode. When the operating mode switching portion 3-9 is in a state that is switched to the normal operating mode, the driving portion MD in the electrically-operated device 3 operates with a high response speed. Moreover, the controlling portion 3E drives the receiving portion 3F and the transmitting portion 3G frequently to receive and transmit information. When the operating mode switching portion 3-9 is in a state wherein it is switched to the low-power operating mode, then, in the electrically-operated device 3, the driving portion MD is operated with a low response speed. Moreover, the controlling portion 3E drives the receiving portion 3F and the transmitting portion 3G infrequently to receive and transmit information.

When in the normal operating mode the controlling portion 3E, the work quantity summing portion 3-1 inputs the torque T from the torque sensor S1 and the angular velocity ω from the angular velocity sensor S2 and sums the amounts of work of the driving portion MD during the operating period as ΣT·ω·t(J), to perform a summation of the total amount of work during the operating period in the same way as above. Note that the torque T may be obtained from a calculation from the motor terminal voltage, the motor current, or the speed of rotation of the motor. Moreover, the angular velocity ω may be obtained from a calculation from the angle of rotation and the time of rotation.

When the supplyable electric energy evaluating time is reached, in the controlling portion 3E the work quantity forecasting portion 3-2 forecasts the amount of work for the driving portion MD for the operating period for forecasting for the day in the same manner as in the first example based on the amounts of work for the driving portion MD in the operating periods prior to that day, which are stored in the work quantity summing portion 3-1.

In the controlling portion 3E, the total required electric energy forecasting portion 3-3 forecasts a total required DC electric energy A for the device for the operating period for forecasting based on the total amount of work of the driving portion MD forecasted by the work quantity forecasting portion 3-2. In this case, the amount of work of the driving portion MD, forecasted by the work quantity forecasting portion 3-2, is converted into a DC electric energy, where that converted DC electric energy is added to the electric energies required by the controlling portion 3E, the receiving portion 3F, the transmitting portion 3G, and the like, at the time of normal operation, to produce the total required DC electric energy A for the device for the operating period for forecasting.

When the supplyable electric energy evaluating time has arrived, in the controlling portion 3E, the stored electric energy calculating portion 3-4 calculates the stored energy as ½ CV²(J) from the capacitance value C for the electricity storing portion 3I and the charge voltage value V at the present time, and converts this stored energy into an electric energy value to calculate the DC electric energy (the stored electric energy) B remaining at that time in the electricity storing portion 3I.

When the supplyable electric energy evaluating time is reached, in the controlling portion 3E the distribution electric energy calculating portion 3-5 calculates the per-unit-time power W based on the electric current value and the voltage at that time in the rectifying portion 3H, and with the time interval from the present time until the time at the end of the operating period for forecasting defined as t1, calculates an estimated DC electric energy (electric power distribution) C that can be extracted from the electromagnetic waves from the wireless electric energy supplying device 2 by the rectifying portion 3H as the W·t1.

In the controlling portion 3E, the supplyable electric energy calculating portion 3-6 adds together the DC electric energy (the stored electric energy) B that is currently remaining in the electricity storing portion 3I, calculated by the stored electric energy calculating portion 3-4, and the estimated DC electric energy (the electric power distribution) C that is to be extracted from the electromagnetic waves from the wireless electric energy supplying device 2 by the rectifying portion 3H between the current time and the time at the end of the operating period for forecasting, calculated by the distribution electric energy calculating portion 3-5, to calculate, as the supplyable DC electric energy D that can be supplied during the operating period for forecasting, this summed DC electric energy B+C.

In the controlling portion 3E, the first electric energy comparing portion 3-71 compares the total required DC electric energy A of the operating period for forecasting, calculated by the total required electric energy forecasting portion 3-3, and the supplyable DC electric energy D for the operating period for forecasting, calculated by the supplyable electric energy calculating portion 3-6.

Here if the supplyable DC electric energy D for the operating period for forecasting is less than the total required DC electric energy A of the operating period for forecasting (D<A), then an instruction for switching from the normal operating mode to the low-power operating mode is sent to the operating mode switching portion 3-9. Additionally, a notification is sent to the work quantity forecasting portion 3-2 and the total required electric energy forecasting portion 3-3 that there has been a switch from the normal operating mode to the low-power operating mode.

When the work quantity forecasting portion 3-2 is notified by the first electric energy comparing portion 3-71 that there will be a switch to the low-power operating mode, the work quantity forecasting portion 3-2 forecasts, as the total amount of work when in the low-power operating mode, a total amount of work for the driving portion MD for the operating period for forecasting for the case of operating in the low-power operating mode, based on the total amount of work of the driving portion MD in the operating periods up to the previous day, which are stored in the work quantity summing portion 3-1. In this example, the forecasted value for the total amount of work for the driving portion MD during the operating period for forecasting for the case of operating in the normal operating mode is reduced by a prescribed proportion to produce the total amount of work for the driving portion MD for the operating period for forecasting for the case of operating in the low-power operating mode (the total amount of work when in the low-power operating mode).

When notified of the switch to the low-power operating mode by the first electric energy comparing portion 3-71, the total required electric energy forecasting portion 3-3 forecast a total required quantity A′ for the device when in the low-power operating mode for the operating period for forecasting based on the total amount of work for the driving portion MD when in the low-power operating mode which was forecasted by the work quantity forecasting portion 3-2. In this case, the total amount of work for when in the low-power operating mode for the driving portion MD, forecasted by the work quantity forecasting portion 3-2, is converted into a DC electric energy value, where this converted DC electric energy is added to the low-power operating mode electric energies required by the controlling portion 3E, the receiving portion 3F, and the transmitting portion 3G, to produce a total required DC electric energy A′ for the low-power operating mode for the device for the operating period for forecasting.

The total required DC electric energy A′ for the low-power operating mode for the operating period for forecasting, calculated by the total required electric energy forecasting portion 3-3 is sent to the second electric energy comparing portion 3-72. The second electric energy comparing portion 3-72, when sent the total required DC electric energy A′ for the low-power operating mode for the operating period for forecasting from the total required electric energy forecasting portion 3-3, compares the total required DC electric energy A′ for the low-power operating mode for the forecasted operating period, which has been sent, with the supplyable DC electric energy D for the operating period for forecasting, calculated by the supplyable electric energy calculating portion 3-6, and sends the comparison result to the notifying portion 3-8.

If here the comparison result of the second electric energy comparing portion 3-72 is that the supplyable DC electric energy D for the operating period for forecasting is equal to or greater than the total required DC electric energy A′ for the low-power operating mode for the forecasted operating period, then the notifying portion 3-8 does not request the wireless electric energy supplying device 2 to increase the electric power distribution level. In this case, switching to the low-power operating mode prevents an insufficiency in the electric energy reception by the electrically-operated device 3, to secure the minimum operations of the electrically-operated device 3 in the operating period for forecasting.

In contrast, if the comparison result of the second electric energy comparing portion 3-72 is that the supplyable DC electric energy D for the operating period for forecasting is less than the total required DC electric energy A′ for the low-power operating mode for the forecasted operating period, (D<A′), then the notifying portion 3-8 provides notification, to the wireless electric energy supplying device 2, of a request for an increase in the electric power distribution level by a specific amount ΔPW.

In this case, the controlling portion 3E waits for the time required for the electric power distribution level in the wireless electric energy supplying device 2 to increase by the specific quantity ΔPW, and then repeats the calculation of the stored electric energy B by the stored electric energy calculating portion 3-4 and the distribution electric energy C by the distribution electric energy calculating portion 3-5. Given this, the stored electric energy B, calculated by the stored electric energy calculating portion 3-4, and the distribution electric energy C, calculated by the distribution electric energy calculating portion 3-5 are totaled by the supplyable electric energy calculating portion 3-6, to recalculate the supplyable DC electric energy D for the operating period for forecasting, and then the total required DC electric energy A′ for the low-power operating mode for the operating period for forecasting, calculated by the total required electric energy forecasting portion 3-3, and the supplyable DC electric energy D for the operating period for forecasting, calculated by the supplyable electric energy calculating portion 3-6, are compared again in the second electric energy comparing portion 3-72.

If here the supplyable DC electric energy D for the operating period for forecasting is still less than the total required DC electric energy A′ for the low-power operating mode for the operating period for forecasting (D<A′), then a notification is sent again from the notifying portion 3-8 to the wireless electric energy supplying device 2 requesting another increase in the electric power distribution level by the specific amount ΔPW, and the operation described above is repeated. This operation is repeated until the supplyable DC electric energy D for the operating period for forecasting reaches or exceeds the total required DC electric energy A′ for the low-power operating mode for the operating period for forecasting (D≧A′). This protects against an insufficiency in the received electric energy in the electrically-operated device 3, ensuring proper operation of the electrically-operated device 3 during the operating period for forecasting.

Note that while the wireless electric energy supplying device 2 receives and follows the requests, from the electrically-operated device 3, for increasing the electric power distribution level by the specific amounts ΔPW after the electrically-operated vice 3 has gone into the low-power operating mode, if the evaluation by the system controlling portion 2B is that there is a human present in the indoor space 1, it does not change the electric power distribution level so as to exceed PWsafe. While, in this example, it is not possible to cause the supplyable DC electric energy D for the operating period for forecasting to be equal to or greater than the total required DC electric energy A′ for the low-power operating mode for the operating period for forecasting (D≧A′) in the electrically-operated device 3, a state is maintained that does not exceed the power level PWsafe wherein there is no risk of affecting a human body within the indoor space 1.

Moreover, if, based on the comparison result by the second electric energy comparing portion 3-72, the supplyable DC electric energy D for the operating period for forecasting is greater than or equal to the total required DC electric energy A for the normal operating mode for the operating period for forecasting (D≧A), then if that difference is greater than a value that has been set in advance, the notifying portion 3-8 provides a notification to the wireless electric energy supplying device 2 requesting a decrease in the electric power distribution level by a specific amount ΔPW. This prevents waste of the electric power distributed in the wireless electric energy supplying device 2.

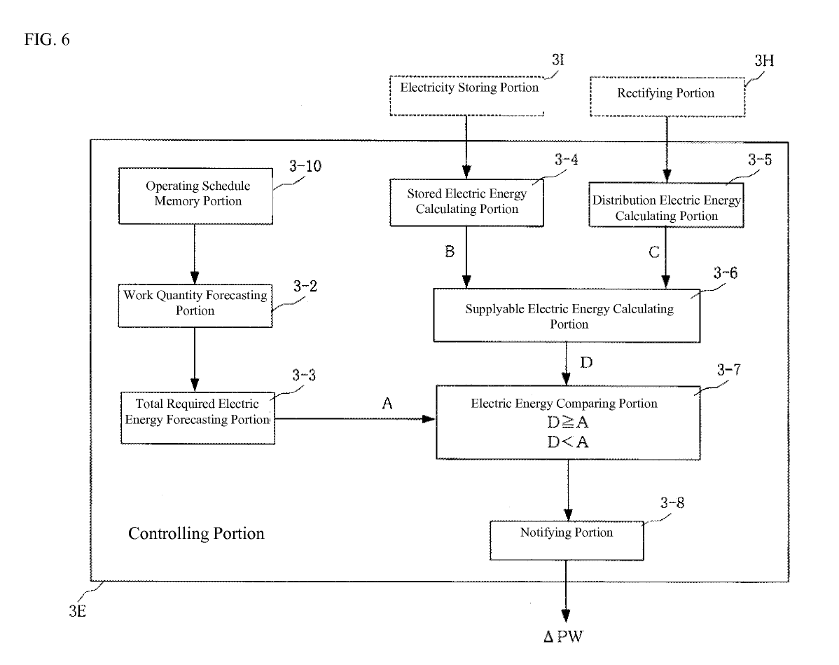

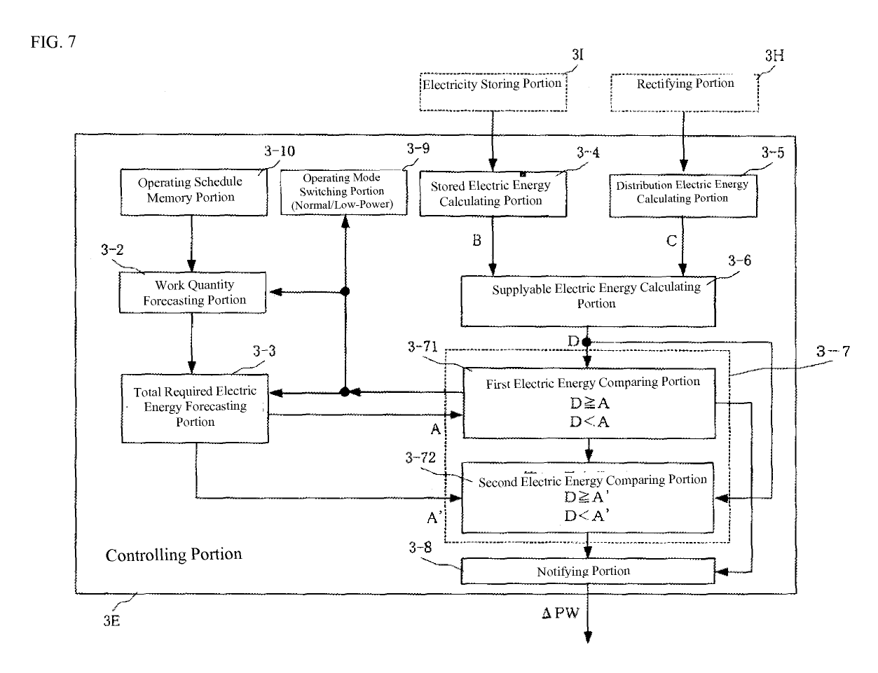

Note that while in the examples (FIGS. 4 & 5), described above, the amounts of work of the driving portion MD during the operating period were calculated and summed in the work quantity summing portion 3-1 and the total amount of work for the driving portion MD in an operating period for forecasting was forecasted in the work quantity forecasting portion 3-2 based on the total amount of work in the operating periods up to that point, summed by the work quantity summing portion 3-1, instead, as shown in FIG. 6 and FIG. 7, an operating schedule memory portion 3-10 for storing the operating schedule for the operating periods of the driving portion MD (for example, an operating schedule for operating periods such as workdays or non-workdays) may be provided, and the total amount of work for the driving portion MD in an operating period for forecasting may be forecasted in work quantity summing portion 3-1 based on the operating schedule of the operating period stored in the operating schedule memory portion 3-10.

Moreover, while in the example set forth above, the time band from 6:00 AM through 10:00 PM was established as a “potentially present” time band (and the time band from 10:00 PM to 6:00 AM was established as a “not potentially present” time band), where the low-power electromagnetic waves were transmitted from the wireless electric energy supplying device 2 into the indoor space 1 when in the potentially-present time band and the high-power electromagnetic waves were transmitted from the wireless electric energy supplying device 2 into the indoor space 1 during the not-potentially-present time band, instead the configuration may be one wherein electric energy is supplied to the electrically-operated device 3 by the electromagnetic waves only during the not-potentially-present time band, with no supply of electric energy to the electrically-operated device 3 through electromagnetic waves during the potentially-present time band.

In such an approach, in the examples (FIGS. 4 & 5) set forth above, the estimated DC electric energy (the distribution electric energy) C that can be extracted from the electromagnetic waves by the rectifying portion 3H from the present time to the time of the end of the operating period for forecasting can be zero, so the supplyable DC electric energy D that can be supplied during the operating period for forecasting can be only the DC electric energy (the stored electric energy) B that is currently stored in the electricity storing portion 3I. While in this case it is not possible to increase the electric power distribution level during the operating period for forecasting, it is possible to increase the electric power distribution level during the electric energy supplying period after the end of the operating period for forecasting through providing notification, to the wireless electric energy supplying device 2, of a result of a comparison by the electric energy comparing portion 3-7 so as to increase the stored electric energy B that can be used in the subsequent operating period for forecasting, so as to eliminate insufficiencies in the electric energy reception.

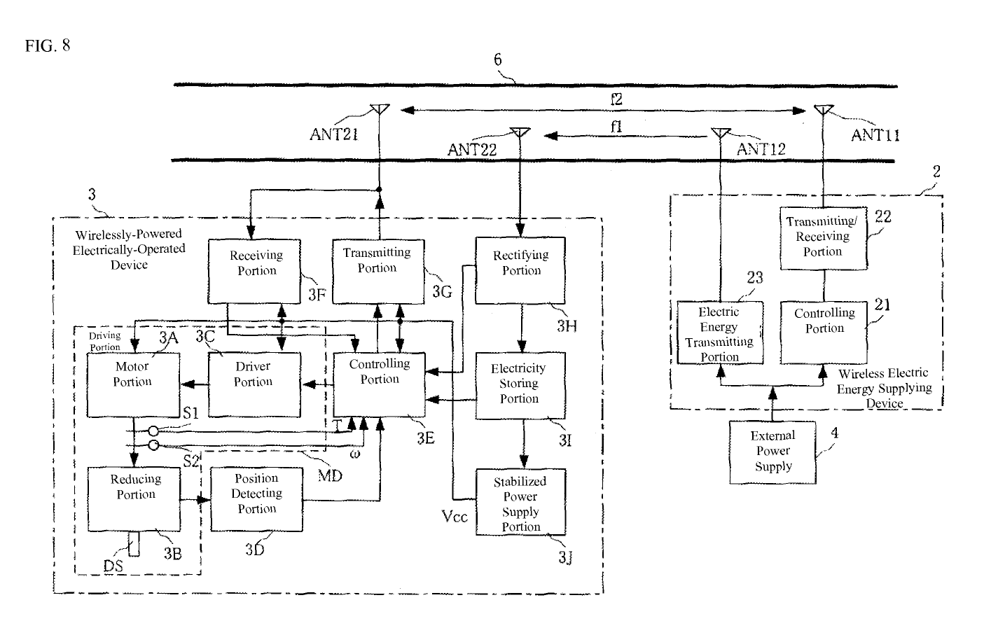

FIG. 8 is a diagram illustrating portions of another example of a wireless electric power distributing system that uses the wirelessly-powered electrically-operated device according to the present examples. In this wireless electric power distribution system, a metal duct 6 is used as a conduction path for the electromagnetic waves from the wireless electric energy supplying device 2 to the electrically-operated device 3.

Moreover, in this example, the wireless electric energy supplying device 2 is provided with a controlling portion 21, a transmitting/receiving portion 22, an electric energy transmitting portion 23, a transmitting/receiving antenna ANT11 that is provided for the transmitting/receiving portion 22, and an electric energy transmitting antenna ANT12 that is provided for the electric energy transmitting portion 23. The transmitting/receiving antenna ANT11 and the electric energy transmitting antenna ANT12 are provided protruding into a duct 6.

In the wireless electric energy supplying device 2, the electric energy transmitting portion 23 runs by receiving a supply of power from an external power supply 4, and transmits electromagnetic waves at a first frequency f1 (for example, in the 800 MHz band) from the electric energy transmitting antenna ANT12. In this case, the electric energy transmitting portion 23 transmits electromagnetic waves, of between several watts and several dozen watts, periodically, at short intervals, as electromagnetic waves of the first frequency f1.

In the wireless electric energy supplying device 2, the controlling portion 21 runs on electric energy received from the external power supply 4, and transmits control data (control data for the driving portion MD) to the electrically-operated device 3 through the transmitting/receiving portion 22 from the transmitting/receiving antenna ANT11 on electromagnetic waves of a second frequency f2 (for example, in the 2.4 GHz band) that is different from the first frequency f1.

The electrically-operated device 3 can be structured identically to the electrically-operated device 3 shown above, but can be different in the points that a transmitting/receiving antenna ANT21 is provided for the transmitting portion 3G and the receiving portion 3F, and that an electric energy receiving antenna ANT22 is provided for the rectifying portion 3H. The transmitting/receiving antenna ANT21 and the electric energy receiving antenna ANT22 can be provided protruding into the duct 6.

In the electrically-operated device 3, the electric energy receiving antenna ANT22 receives the electromagnetic waves of the first frequency f1 that are transmitted by the electric energy transmitting antenna ANT12 of the wireless electric energy supplying device 2. The electromagnetic waves of the first frequency f1 that are received by the electric energy receiving antenna ANT22 are sent to the rectifying portion 3H. The rectifying portion 3H rectifies the energy of the electromagnetic waves of the first frequency f1, received by the electric energy receiving antenna ANT22, to extract DC electric energy. The DC electric energy extracted by the rectifying portion 3H is stored in the electricity storing portion 3I.

In the electrically-operated device 3, the transmitting/receiving antenna ANT21 receives the electromagnetic waves of the second frequency f2 that carry the control data to the driving portion MD, sent from the transmitting/receiving antenna ANT11 of the wireless electric energy supplying device 2. The electromagnetic waves of the second frequency f2, received by the transmitting/receiving antenna ANT21, are sent to the receiving portion 3F. The receiving portion 3F extracts, from the electromagnetic waves of the second frequency f2 that are received by the transmitting/receiving antenna ANT21, the control data for the driving portion MD that is sent on those electromagnetic waves, and the extracted control data is sent to the controlling portion 3E.

The controlling portion 3E drives the motor 3A through the driver portion 3C based on the control data for the driving portion MD from the receiving portion 3F. The torque of the motor 3A is transmitted to the driveshaft DS through the reducing portion 3B. The degree of opening of a damper, not shown, is changed thereby. The position detecting portion 3D detects the degree of opening of the damper, which changes over time, and feeds it back to the controlling portion 3E. The controlling portion 3E controls the driving of the motor 3A to cause the degree of opening of the damper (the actual degree of opening) that is fed back from the position detecting portion 3D to match the degree of opening of the damper (the setting degree of opening) that is directed by the control data to the driving portion MD. Moreover, the controlling portion 3E sends to the transmitting portion 3G, as data to be transmitted to the outside, the degree of opening of the damper that is detected by the position detecting portion 3D, to be sent through the transmitting/receiving antenna ANT21, to be transmitted to the wireless electric energy supplying device 2 side on the electromagnetic waves of the frequency f2.

In the wireless electric power distributing system of this example, the controlling portion 3E of the electrically-operated device 3 has supplyable electric energy evaluating functions that are identical to those explained in the above example.

Note that the aforementioned transmitting/receiving antenna ANT11, the electric energy transmitting antenna ANT12, the transmitting/receiving antenna ANT21, and the electric energy receiving antenna ANT22 may each use dipole antennas that have antenna lengths that are half of the wavelength for the frequencies to be transmitted and received. However, the lengths and the types of the individual antennas are not limited to those of the one-half wavelength dipole antennas, but rather may be one-wavelength dipole antennas, whip antennas, sleeve antennas, or loop antennas, or may be planar antennas, Yagi antennas, or the like, described below. That is, insofar as they transmit and receive electromagnetic waves of specific frequencies within the duct 6 there is no particular limitation to the type.

Additionally, although not shown in particular, reflectors that are structured from, for example, flat plates that are made out of metal may be provided at specific locations to the rear of the respective antennas relative to the direction from the transmitting/receiving antenna ANT11 to the transmitting/receiving antenna ANT21, and in specific locations to the rear of the respective antennas relative to the direction from the electric energy transmitting antenna ANT12 to the electric energy receiving antenna ANT22, to produce structures, from these reflectors, for reflecting the electromagnetic waves that are transmitted by the individual antennas. These reflectors play a role of applying specific directionality to the transmitting/receiving antenna ANT11, the electric energy transmitting antenna ANT12, the transmitting/receiving antenna ANT21, and the electric energy receiving antenna ANT22.

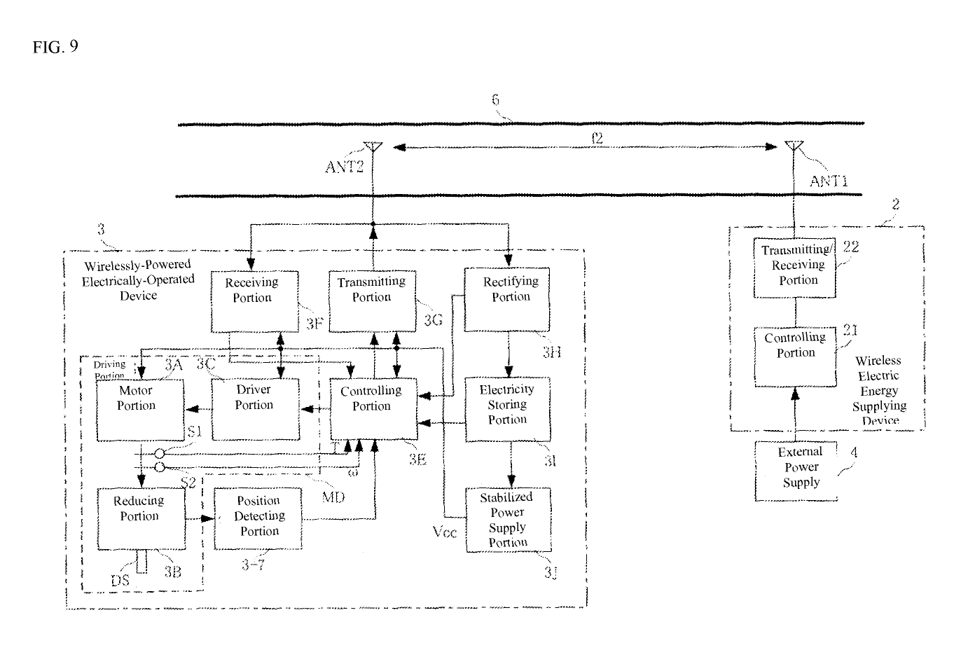

FIG. 9 is a diagram illustrating portions of yet another example of a wireless electric energy distributing system that uses the wirelessly-powered electrically-operated device according to the above examples. The points of difference between the examples are the point that the electric energy transmitting antenna ANT12 and the electric energy transmitting portion 23 of the wireless electric energy supplying device 2 have been eliminated, and the point that the electric energy receiving antenna ANT22 is eliminated from the electrically-operated device 3 and the electromagnetic waves of the second frequency f2 (the electromagnetic waves that carry the control data to the driving portion MD), received by the transmitting/receiving antenna ANT21, are directed to the rectifying portion 3H.

Note that in this example, the wireless electric energy supplying device 2 transmits periodically, at frequent intervals, electromagnetic waves at the frequency f2 from the transmitting/receiving antenna ANT1 even when there is no control data. Moreover, in this example, the controlling portion 3E of the electrically-operated device 3 can have the same supplyable electric energy evaluating functions as explained above.

In this wireless electric power distributing system, the wireless electric energy supplying device 2 periodically, at frequent intervals, transmits into the duct 6 electromagnetic waves of a frequency f2 (for example, in the 2.4 GHz band) from the transmitting/receiving antenna ANT1. These electromagnetic waves arrive at the transmitting/receiving antenna ANT2 of the electrically-operated device 3, either directly or while being reflected from the inside wall surfaces of the metal duct 6. In the electrically-operated device 3, the energy of the electromagnetic waves of the frequency f2, received by the transmitting/receiving antenna ANT2, is converted into DC electric energy by the rectifying portion 3H, and the extracted DC electric energy is stored in the electricity storing portion 3I. The electric energy required in the electrically-operated device 3 is covered by the DC electric energy that is stored in the electricity storing portion 3I.

The electric energy required in the electrically-operated device 3 is received by the transmitting/receiving antenna ANT2, that is, the transmitting/receiving antenna ANT2 also functions as the antenna for receiving the control data, thus simplifying the structure. Moreover, in the third form of embodiment there is no need to provide either the electric energy transmitting portion 23 or the electric energy transmitting antenna ANT12 in the wireless electric energy supplying device 2, which is desirable because it can be achieved without altering the fundamental structure of the wireless electric energy supplying device 2.

Note that while in the examples set forth above the explanation was for a case wherein electromagnetic waves were used for the wave motion, the wave motion need not be limited to electromagnetic waves, but instead light, ultrasonic waves, or the like, may be used for the wave motion. If the wave motion is in the form of light, laser beam emitting device, an LED, a light bulb, or the like, may be used for the transmitting device, and a solar cell, a photodiode, or the like, may be used as the receiving device. Moreover, if the wave motion is in the form of ultrasonic waves, a piezo oscillator, or the like, or an electrostrictive oscillator may be used as the transmitting/receiving device.

Moreover, while in the forms of embodiment set forth above the total required DC electric energy and the supplyable DC electric energy were converted into electric energies for the comparison, the energies may be compared without converting into electric energies.

The wirelessly-powered electrically-operated device according to the present examples may be used not only in buildings, but also in a variety of locations such as work areas in factories, plants, and the like, as wirelessly-powered electrically-operated devices that receive wave motion, such as electromagnetic waves, and use, as their operating power supplies, electric energy extracted from the wave motion that has been received.

We claim:

1. A wirelessly-powered electrically-operated device comprising a wave receiving portion receiving wave motion that is transmitted wirelessly, an energy extracting portion extracting, as energy, the wave motion received by the wave receiving portion, an electricity storing portion for storing the energy extracted by the energy extracting portion, and a driving portion that is driven by receiving a supply of energy that is stored in the electricity storing portion, comprising:
a work quantity forecasting device defining, as an operating period for the driving portion, a specific period that is set in advance, and defining, prior to entering into that operating period, the operating period as an operating period for forecasting, to forecast the total amount of work of the driving portion in the operating period for forecasting;
a total required energy forecasting device forecasting the total required energy in the device for the operating period for forecasting based on the total amount of work of the driving portion forecasted by the work quantity forecasting device;
a supplyable energy calculator summing, prior to entering into the operating period for forecasting, an amount of energy that remains, at that time, in the electricity storing portion and an estimated energy to be extracted from the wave motion by the energy extracting portion between the current time and the time of the end of the operating period for forecasting, to calculate the summed energies as the supplyable energy that can be supplied during the operating period for forecasting;
an energy comparing device comparing the total required energy for the operating period for forecasting, forecasted by the total required energy forecasting device, and the supplyable energy for the operating period for forecasting, calculated by the supplyable energy calculator; and
a notifying device providing notification of information based on the comparison results by the energy comparing device.

2. A wirelessly-powered electrically-operated device comprising a wave receiving portion receiving wave motion that is transmitted wirelessly, an electric energy extracting portion extracting, as electric energy, the wave motion received by the wave receiving portion, an electricity storing portion storing the electric energy extracted by the electric energy extracting portion, and a driving portion that is driven by receiving a supply of electric energy that is stored in the electricity storing portion, comprising:
a work quantity forecasting device defining, as an operating period for the driving portion, a specific period that is set in advance, and for defining, prior to entering into that operating period, the operating period as an operating period for forecasting, to forecast the total amount of work of the driving portion in the operating period for forecasting;
a total required electric energy forecasting device forecasting the total required electric energy in the device for the operating period for forecasting based on the total amount of work of the driving portion forecasted by the work quantity forecasting device;
a supplyable electric energy calculator summing, prior to entering into the operating period for forecasting, an amount of electric energy that remains, at that time, in the electricity storing portion and an estimated electric energy to be extracted from the wave motion by the electric energy extracting portion between the current time and the time of the end of the operating period for forecasting, to calculate the summed electric energies as the supplyable electric energy that can be supplied during the operating period for forecasting;
an electric energy comparing device comparing the total required electric energy for the operating period for forecasting, forecasted by the total required electric energy forecasting device, and the supplyable electric energy for the operating period for forecasting, calculated by the supplyable electric energy calculator; and
a notifying device providing notification of information based on the comparison results by the electric energy comparing means.

3. The wirelessly-powered electrically-operated device as set forth in claim 2, comprising:
a work quantity summing device measuring and summing amounts of work of the driving portion during operating periods; wherein:
the work quantity forecasting device forecasts the total amount of work of the driving portion for an operating period for forecasting based on the total amounts of work of operating periods summed by the work quantity summing device.

4. The wirelessly-powered electrically-operated device as set forth in claim 2, comprising:
an operating schedule storing device storing an operating schedule of the operating period for the driving portion; wherein:
the work quantity forecasting device forecasts a total amount of work for the driving portion during an operating period for forecasting based on the operating schedule of the operating period stored in the operating schedule storing device.

5. The wirelessly-powered electrically-operated device as set forth in claim 2, wherein:
the notifying device provides notification of a request for an increase in the energy level of the wave motion that is transmitted when, based on a result of a comparison by the electric energy comparing device, the supplyable DC electric energy for an operating period for forecasting is less than the total required DC electric energy for the operating period for forecasting.

6. The wirelessly-powered electrically-operated device as set forth in claim 2, comprising:
an operating mode switch switching between a normal operating mode and a low-power operating mode that can operate on less electric energy than the normal operating mode, wherein:
the operating mode switch switches from the normal operating mode to the low-power operating mode when, based on a result of a comparison by the electric energy comparing device, the supplyable DC electric energy for an operating period for forecasting is less than the total required DC electric energy for the operating period for forecasting.

7. The wirelessly-powered electrically-operated device as set forth in claim 6, wherein:
when, based on a result of a comparison by the electric energy comparing device, the supplyable DC electric energy for an operating period for forecasting is less than the total required DC electric energy for the operating period for forecasting:
the work quantity forecasting device forecasts, as a low-power operating mode total amount of work, the total amount of work of the driving portion in the operating period for forecasting for the case of the low-power operating mode;
the total required energy forecasting device forecasts a low-power operating mode total required DC electric energy for the device for the operating period for forecasting based on the low-power operating mode total amount of work of the driving portion that was forecasted by the work quantity forecasting device;
the electric energy comparing device compares the low-power operating mode total required DC electric energy for the operating period for forecasting, forecasted by the total required electric energy forecasting device, and the supplyable DC electric energy for the operating period for forecasting, calculated by the supplyable electric energy calculator; and
the notifying device provides notification of a request for an increase in the energy level of the wave motion that is transmitted if, based on the result of the comparison by the electric energy comparing device, the supplyable DC electric energy for the operating period for forecasting is less than the low-power operating mode total required DC electric energy for the operating period for forecasting.
